(19) United States
(12) Patent Application Publication
(10) Pub. No.: US 2006/0204931 A1
(43) Pub. Date: Sep. 14, 2006

(54) Dental prosthesis and method

(75) Inventors: Robert Ibsen, Santa Maria, CA (US); William R. Glace, Santa Maria, CA (US)

Correspondence Address: CROWELL & MORING LLP;INTELLECTUAL PROPERTY GROUP, P.O. BOX 14300, WASHINGTON, DC, 20044-4300, US

(73) Assignee: DEN-MAT CORPORATION

(21) Appl. No.: 11/356,087

(22) Filed: Feb. 17, 2006

Related U.S. Application Data
(60) Provisional application No. 60/653,518, filed on Feb. 17, 2005.

(51) Int. Cl. A61C 13/225; A61C 13/12

(52) U.S. Cl. 433/180

(57) ABSTRACT

A dental prosthesis and method of forming a dental prosthesis. The prosthesis comprises a pontic and huggers that conform to the surface of abutment teeth around a gap filled by the pontic. Installation of the prosthesis does not require damaging or altering the abutment teeth.

### BACKGROUND

1. Field of the Invention

The invention relates to dentistry. In particular, the instant invention relates to dental prosthetics and bridges.

2. State of the Art

Dental prosthetics are well known. A common dental prosthesis is a dental bridge. Dental bridges or partial dentures, comprise an artificial tooth or teeth, known as a “pontic”, which extends along the line of the dental arch and is supported on each side by a suitably prepared sound natural tooth, known as an “abutment tooth”. A variety of different connectors are known for securing a pontic to abutment teeth.

The abutment teeth usually have to be prepared by surgery, and in one method they are reduced to parallel sided pillars. A dental bridge is constructed by a technician with caps that fit precisely over the abutment teeth on either side of the pontic, and the bridge is secured using dental cement. This method has a major disadvantage that high bending stresses arise in use on the pontic and the abutment teeth, which are liable to damage the abutment teeth, or may result in the dental cement shearing and the bridge being dislodged. Such bending stresses can arise in the first instance because of imperfections of fit, but even if this is avoided, movements of the abutment teeth, in use, and with the passage of time, give rise to substantial stresses. Of particular importance, of course, are the occlusal loadings that are applied in mastication and there have been many proposals to provide dental prostheses with supports that have stress-breaking capabilities, i.e. that reduce these bending stresses.

One arrangement has been proposed (U.S. Pat. No. 1,664,433) using a crown on the abutment tooth which allows relative vertical movements between the pontic and the abutment tooth, so that direct occlusal pressure can be transmitted to the gums beneath the pontic, but it makes no provision to prevent bending and torsional strains being transmitted to the abutment tooth

A procedure for forming such a bridge is shown in FIGS. 1-3. In FIG. 1, a pair of teeth are shown with a missing tooth therebetween. The first step involves preparing the abutment teeth for acceptance of the crowns. Healthy tooth tissue is removed from the teeth to render the tooth shapes shown in FIG. 2. A bridge can then be installed. Commonly the bridge is made of metal. The comprises crowns covering each adjacent tooth and a pontic in the space between the teeth. The bridge is secured by cementing the crowns over the abutment teeth such that the pontic is supported in the space formerly filled by the missing tooth. FIG. 3 shows a cross-sectional view of the teeth after the bridge has been installed. The view is taken half way between the biting surface of the teeth and the gums.

This method disadvantageously requires altering healthy teeth. Such altering may comprise grinding which may be very uncomfortable to a patient. Further, the strength of the abutment teeth may be significantly reduced by the alteration. Accordingly, significant force inflicted on the pontic or the abutment teeth themselves could cause serious damage. Further, the metal bridge may cause mental trauma to the patient.

Therefore, a need remains for a dental prosthesis and method of forming such a prosthesis that does not require removing healthy tooth structure. The present invention provides a dental prosthesis and method of forming thereof that does not require damaging abutment teeth and does not cause mental trauma

### SUMMARY

One embodiment of the invention is a dental prosthesis. The dental prosthesis includes a pontic and a set of lateral arms, or “hugger”, protruding from each side thereof. The prosthesis is for filling a gap caused by at least one missing tooth between two natural or artificial teeth. The hugger on each side of the pontic conform to the surface morphology of the abutment tooth.

Another embodiment of the invention is a method for forming a dental prosthesis. The method includes filling a gap caused by at least one missing tooth between two natural or artificial teeth. The gap is filled with a hybrid composite resin. The resin is provided between the two teeth and around at least a portion of the two teeth. The portion around the two teeth conforms to the surface morphology of the teeth. A tooth bonding agent may be provided to the abutment teeth to cement the bridge in place.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

FIG. 1 shows a gap caused by a missing tooth between two abutment teeth.

FIG. 2 shows prepared abutment teeth in formation of a prior art bridge.

FIG. 3. shows a cross-sectional view of the teeth after a prior art bridge has been formed.

FIG. 4 shows a cross-sectional view of a dental prosthesis of an embodiment of the invention between two abutment teeth.

### DETAILED DESCRIPTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implicated in other compositions and methods, and that any such variation would be within such modifications that do not part from the scope of the present invention. Before explaining the disclosed embodiments of the present invention in detail, it is to be understood that the invention is not limited in its application to the details of any particular embodiment shown, since of course the invention is capable of other embodiments. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

The dental prosthesis of one embodiment of the present invention comprises a pontic and two sets of lateral arms, or “huggers”, protruding from each side of the pontic. The pontic fills the gap between two teeth and the huggers conform to the morphology of the two teeth. The prosthesis is formed from a hybrid composite resin. A tooth-bonding agent is used to cement the prosthesis in place.

The hybrid composite resin is preferably methacrylate resin-based. An exemplary hybrid composite resin is True Vitality produced by the Den-Mat Corporation. However, any dental composite could be used.

The tooth-bonding agent is preferably a solvent-based crosslinkable acrylic resin. An exemplary tooth-bonding agent is Tenure™ produced by the Den-Mat Corporation. However, any dental bonding agent could be used.

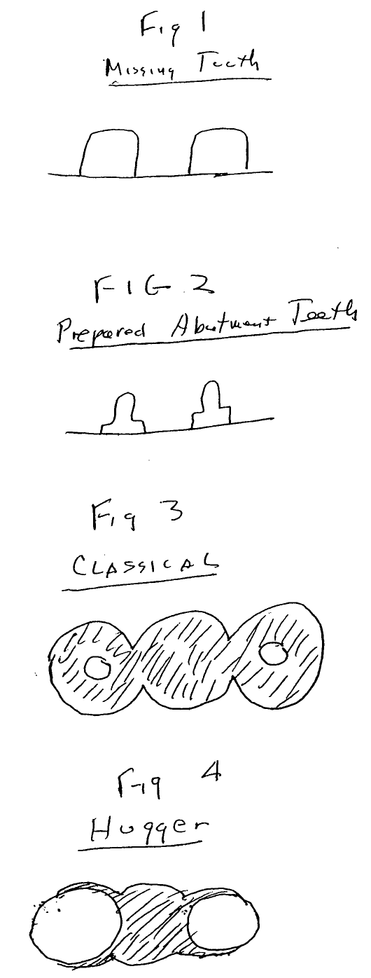

The method of forming the dental prosthesis of one embodiment of the invention includes providing a tooth-bonding agent to at least a portion of two teeth abutting a gap caused by a missing tooth on either side of the gap. Such a gap and abutment teeth is shown in FIG. 1 before the tooth-bonding agent has been applied. A dental composite is then provided in the gap and around at least a portion of teeth. The dental composite fills the gap between the teeth and includes huggers on each side of the gap. The portion that fills the gap creates a pontic or artificial tooth. The huggers conform to the surface morphology of the abutment teeth. Preferably, the tooth-bonding agent is only applied to the portion of an abutment tooth that the dental composite contacts. FIG. 4 shows a cross-sectional view of the teeth and gap after the dental composite has been applied. The view is taken half way between the biting surface of the teeth and the gums.

Prior to installing a dental bridge in the mouth of the patient, the exposed surfaces of the abutting teeth may be acid-etched utilizing any acid know by one of skill in the art to be effective for such methods. The exposed surfaces of the abutting teeth may be also be polished. The dental bridge is then installed in the mouth of the patient by fixing the huggers to the prepared abutment teeth. The huggers may be attached to the abutting teeth by utilizing a dental composite cement.

While the invention has been described with reference to certain exemplary embodiments thereof, those skilled in the art may make various modifications to the described embodiments of the invention without departing from the scope of the invention. The terms and descriptions used herein are set forth by way of illustration only and are not meant as limitations. In particular, although the present invention has been described by way of examples, a variety of compositions and methods would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A dental prosthesis comprising a pontic and a hugger protruding from each side thereof.

2. The dental prosthesis of claim 1, wherein the hugger on each side of the pontic conforms to the surface morphology of the abutment tooth.

3. The dental prosthesis of claim 1, wherein the dental prosthesis is comprised of a composite resin.

4. The dental prosthesis of claim 1, wherein the dental prosthesis is comprised of a hybrid composite resin.

5. The dental prosthesis of claim 4, wherein the hybrid composite resin is methacrylate resin-based.

6. A dental bridge comprising a pontic and lateral at least one lateral arms for anchoring the dental bridge to the labial or lingual surface of a tooth.

7. The dental bridge of claim 6, wherein the bridge comprises at least two lateral arms for anchoring the dental bridge to the labial or lingual surface of a tooth.

8. The dental bridge of claim 6, wherein the bridge comprises at least three lateral arms for anchoring the dental bride to the labial or lingual surface of a tooth.

9. The dental bride of claim 6, where in the dental bride is comprised of a composite resin.

10. A method for providing a dental bridge to replace at least one missing tooth without substantial removal of portions of abutment teeth comprising the steps of:
providing a dental pontic having at least one lateral arm;
forming a dental preparation on the labial and/or lingual surfaces comprising a bonding agent for bonding at least one lateral arm and tooth material; and
contacting said lateral arm to said bonding agent so that said composite, lateral arm and teeth will be chemically bonded to form a unitary structure.

11. The method of claim 10, wherein the dental bridge is comprised of composite resin.

12. The dental bridge of claim 10, wherein the dental bridge is comprised of hybrid composite resin.

13. The dental bridge of claim 12, wherein the hybrid composite resin is methacrylate resin-base.

14. A dental bridge having the general configuration of a tooth or teeth, with projecting lateral arms which are contiguous with the dental bridge, conterminous with the bridge and formed of the same material as the bridge, said lateral arms being capable of anchoring the dental bridge in position by their contact with labial and/or lingual surfaces of the teeth on either side of the gap in which said bridge is to be inserted.

15. The dental bridge of claim 14, wherein the dental bridge is comprised of composite resin.

16. The dental bridge of claim 14, wherein the dental bridge is comprised of hybrid composite resin.

17. The dental bridge of claim 16, wherein the hybrid composite resin is methacrylate resin-base.
